(19) United States
(12) Patent Application Publication
(10) Pub. No.: US 2026/0032092 A1
(43) Pub. Date: Jan. 29, 2026

(54) PRIORITIZE THE EARLIER STEP MESSAGES FOR COLLECTIVE ALGORITHMS

(71) Applicant: Advanced Micro Devices, Inc., Santa Clara, CA (US)

(72) Inventors: Yanfang LE, Santa Clara, CA (US); Rong PAN, Santa Clara, CA (US); Vipin JAIN, Santa Clara, CA (US); Peter NEWMAN, Santa Clara, CA (US)

(21) Appl. No.: 18/783,180

(22) Filed: Jul. 24, 2024

(51) Int. Cl. H04L 47/78; H04L 47/52

(52) U.S. Cl. CPC H04L 47/782; H04L 47/52

(57) ABSTRACT

Embodiments herein relate to a NIC providing more bandwidth to deliver a packet that is part of a lower hierarchical level of a collective algorithm than a packet that is part of a higher hierarchical level of the collective algorithm, when both packets are ready for transmission. The NIC can allocate an appropriate amount of bandwidth to each packet that ensures the delivery of the packet associated with a respectively lower hierarchical level is prioritized over the packet associated with a respectively higher hierarchical level, which can resolve data dependencies and result in faster execution of the collective algorithm.

### TECHNICAL FIELD

The embodiments presented herein relate to parallel or distributed computing. In parallel or distributed computing, algorithms perform tasks in parallel across multiple different processors or nodes. These processors or nodes coordinate their actions to achieve the common goal of the algorithm.

### BACKGROUND

Collective algorithms commonly use hierarchical communication patterns to execute. The completion of each hierarchical level may depend on the completion of a previous or lower hierarchical level, ensuring these data dependencies are satisfied and the final result is correctly computed. Collective algorithms of this described nature often divide the workload of computing a final result among different processers at different levels of hierarchy. However, these algorithms are susceptible to bottlenecking, as earlier steps, or lower hierarchical levels, of the algorithm may take a considerable amount of time to complete, delaying subsequent steps, or levels of hierarchy, from completing. This bottleneck has the potential to impact overall performance and efficiency of the algorithm, especially in large scale systems where even minor delays can propagate and amplify through the hierarchical levels.

### SUMMARY

In one embodiment, a method is described. The method includes receiving a first packet and a second packet from a node of a collective algorithm, where the first packet corresponds to a first hierarchical level of the collective algorithm, and the second packet corresponds to a second hierarchical level of the collective algorithm; allocating a first amount of bandwidth to the first packet and a second, different amount of bandwidth to the second packet; and transmitting, in parallel, the first packet to a first destination node using the first amount of bandwidth, and the second packet to a second destination node using the second, different amount of bandwidth.

In another embodiment, a network device is described. The network device includes circuitry that may receive a first packet and a second packet from a node of a collective algorithm, where the first packet corresponds to a first hierarchical level of the collective algorithm, and the second packet corresponds to a second hierarchical level of the collective algorithm; allocate a first amount of bandwidth to the first packet and a second, different amount of bandwidth to the second packet; and transmit, in parallel, the first packet to a first destination node using the first amount of bandwidth, and the second packet to a second destination node using the second, different amount of bandwidth.

In another embodiment, a system is described. The system includes a node. The node may generate a first packet, and a second packet, where the first packet comprises an indication of an association with a first hierarchical level, and the second packet comprises an indication of an association with a second hierarchical level; and a network device, wherein the network device is configured to: receive, from the node, the first packet and the second packet; allocate a first amount of bandwidth to the first packet and a second, different amount of bandwidth to the second packet; and transmit, in parallel, the first packet to a first destination node using the first amount of bandwidth, and the second packet to a second destination node using the second, different amount of bandwidth.

### BRIEF DESCRIPTION OF DRAWINGS

FIG. 1 illustrates a node of a collective algorithm transmitting packets, according to one embodiment herein.

FIG. 2 illustrates multiple different hierarchical levels of a collective algorithm, according to one embodiment herein.

FIG. 3 illustrates multiple different hierarchical levels of a collective algorithm, according to one embodiment herein.

FIG. 4 illustrates a flow diagram of the flow of sending two packets in parallel, according to one embodiment herein.

FIG. 5 illustrates a flow diagram illustrating the perspective of the node when sending a packet, according to one embodiment herein.

FIG. 6 illustrates an example data processing unit, according to one embodiment herein.

### DETAILED DESCRIPTION

Embodiments herein relate to the role of a network interface card (NIC) or a data processing unit (DPU) in facilitating communication between nodes of a collective algorithm that uses hierarchical communication patterns to execute. In parallel computing, collective operations such as alltoall and allreduce play a role in coordination data exchange and aggregation among multiple nodes. The NIC serves as an interface between these nodes and the network, facilitating communication and data transfer.

Embodiments herein relate to the NIC (or DPU) facilitating an improvement in the operation and efficiency of collective algorithms.

In the case of an alltoall operation where each node of the collective exchanges data with every other node, the NIC plays a role in managing the transmission and reception of data packets. Each node's NIC initiates the sending of data packets to other nodes, ensuring the data is correctly routed and delivered. The NIC handles communication protocol, packetization, and bandwidth allocation for providing an efficient data exchange.

Similarly, in the case of an allreduce operation, where data from all nodes is aggregated using a certain reduction operation (such as sum, max, etc.) the NIC facilitates the communication and coordination for performing the reduction. For example, each node's NIC can send its data to a central point where the reduction operation is performed, and then have the results broadcast back to all the nodes. This can involve multiple rounds, or hierarchies, of communication between the central point and the nodes. One level of hierarchy of communication may have a data dependency on a previous lower level of hierarchy of communication.

Blocking, or dependency blocking, refers to an issue arising from when part of the computation or communication process of an algorithm is waiting for another part to complete before it can proceed. For example, in the context of collective algorithms with hierarchical structures, blocking can occur when higher level operations, or operations of a higher hierarchical level, are waiting for lower level operations, or operations of a lower hierarchical level, to complete.

The NIC discussed in embodiments herein help prevent blocking problems, and improve efficiency of collective algorithms by allocating and providing different bandwidths to packets for delivery. The bandwidth provided to a packet depends on the level of hierarchy the packet is associated with for delivery. For example, when the NIC has two packets to send to two different levels of the hierarchy, the NIC can provide more bandwidth to deliver the packet to a node of a lower level of the hierarchy that has less data dependencies to satisfy than the packet to a node in a higher level of the hierarchy with respectively more data dependencies to satisfy. This improves the efficiency of the algorithm as providing more bandwidth to deliver packets to nodes of a lower hierarchical level helps ensure that they are delivered before packets to nodes of respectively higher hierarchical levels. The algorithm can run more efficiently by providing more bandwidth to complete the lower hierarchical levels before the algorithm moves to the higher hierarchical levels that may depend on the completion of lower hierarchical levels.

Because the NIC can provide more bandwidth to deliver packets to nodes of lower hierarchical levels, this helps ensure that the lower hierarchical levels' dependencies are satisfied so the higher hierarchical levels can be satisfied without the issue of blocking occurring. The NIC can allocate an appropriate amount of bandwidth to each packet that ensures the delivery of the packet associated with a respectively lower hierarchical level is prioritized over the packet associated with a respectively higher hierarchical level. In certain embodiment herein, that can mean that the NIC provides more bandwidth to deliver packets of respectively lower hierarchical levels, when a node is delivering multiple packets in parallel.

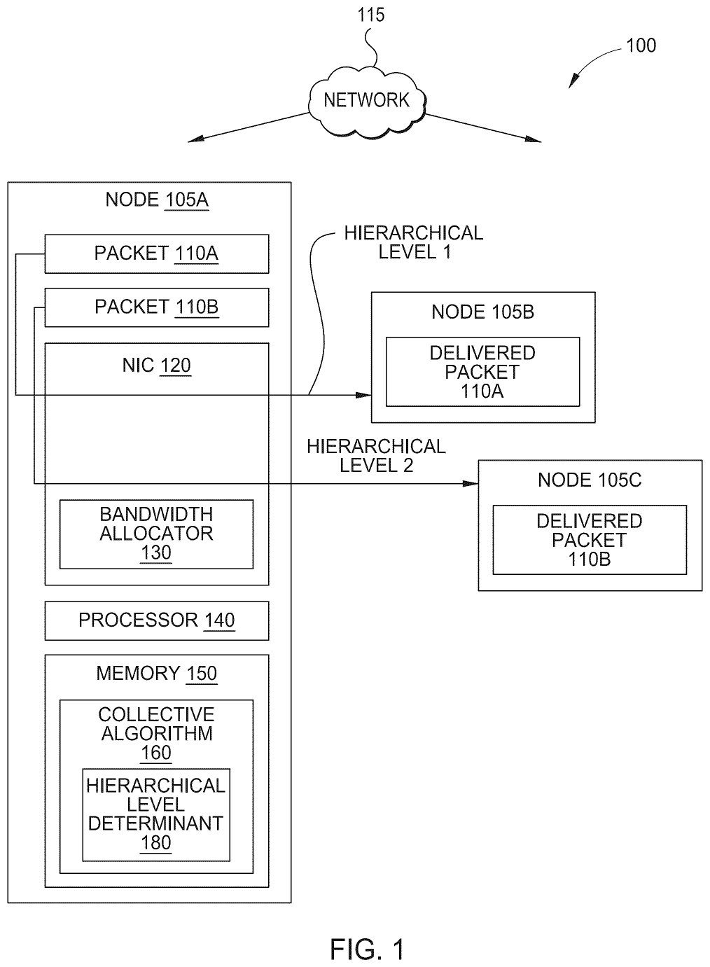

FIG. 1 illustrates a node 105A of a collective algorithm delivering a packet 110B and a packet 110C in parallel to nodes 105B and 105C respectively. The nodes 105A, 105B, and 105C belong to a collective algorithm operating using hierarchical communication patterns. In one embodiment. each node 105 contains a NIC. The NIC 120 in node 105A is responsible for sending and receiving data packets, such as transmitting packets 110A and 110B over the network 115 to other nodes of the collective algorithm, such as nodes 105B and 105C. The network 115 infrastructure enables communication among the nodes of the algorithm. The network 115 may have communication protocols that govern the way data is exchanged, define rules for packet formatting, addressing, routing, and error handling to ensure accurate and efficient transmission. The network 115 can also provide physical and logical framework for transmitting packets between nodes. Examples of physical and logical framework can include but are not limited to switches, routers, cables, and other networking devices. The network 115 can be a private network or a public network (e.g., a data center network).

The node 105A includes the NIC 120 which in turn includes a bandwidth allocator 130, for providing and allocating bandwidth for delivering packets. The amount of allocated bandwidth can be based on the level of hierarchy associated with each packet and its destination node (especially when delivering the packets in parallel). The NIC 120 can act as an intermediary between the node's hardware and the network's 115 infrastructure that facilitates the transmission and reception of data packets. The NIC 120 can implement communication protocols, handle packet formatting and addressing, and ensure that data packets are transmitted accurately and efficiently over the network 115, among other things. The NIC 120 and the network 115 work together to enable communication and packet exchange among nodes of a collective algorithm.

The NIC 120 receives packets 110A and 110B from the node 105A before pushing and delivering them to the destination nodes 105B and 105C respectively. The packets 110A and 110B may include appropriate headers. Headers can contain information such as the destination address, error checking codes, and control signals that the data uses to be correctly routed and received, as well as the hierarchical level of the algorithm associated with the packet and the packet's destination, among other things. This information can be read by the NIC 120. The bandwidth allocator 130 may identify information surrounding the hierarchical level of the algorithm associated with the packet and the packet's destination, and in turn, provide bandwidth for delivering the packets accordingly. It may provide one amount of bandwidth for delivering one packet, and a second, different amount of bandwidth for delivering another packet.

In one embodiment, the bandwidth allocator 130 provides respectively more bandwidth to a packet being delivered that corresponds to a respectively lower hierarchical level than another packet that is to be delivered, when both of the packets are ready to be delivered in parallel. For example, the packet 110A and the packet 110B are both received by the NIC 120 and are both ready to be delivered in parallel. The bandwidth allocator 130 may recognize that the packet 110A is to be delivered to the node 105B, in association with a hierarchical level one, and the packet 110B is to be delivered to the node 105C in association with a hierarchical level two. In response to recognizing this, the bandwidth allocator 130 of the NIC 120 may allocate and provide respectively more bandwidth to deliver the packet 110A than the packet 110B. This can include allocating all of the available bandwidth to deliver the packet 110A, and therefore, none of the available bandwidth to deliver the packet 110B. In another embodiment, a smaller percentage of available bandwidth can be allocated to deliver the packet 110B but a respectively higher percentage of available bandwidth would be allocated to deliver the packet 110A.

One function of the bandwidth allocator 130 of the NIC 120 can be to prioritize sending messages or packets that are to be delivered in association with a respectively lower hierarchical level. Providing more bandwidth to lower hierarchical levels prioritizes the lower-level messages. Providing more bandwidth to lower levels can enable faster and more efficient communication from those lower levels, which can result in the data operations for these levels being completed sooner. In hierarchical collective algorithms, the initial steps of data exchange and aggregation can occur at these lower levels (whether it be within individual nodes or closely connected clusters of nodes). By increasing the bandwidth available for these initial communications, data can be transferred more quickly. The completion of lower level tasks can directly impact the ability of higher level operations to proceed.

Also included in the nodes of a collective algorithm are a processor 140 and memory 150. The processor 140, which can be a central processing unit (CPU) can execute the computational tasks defined by the algorithm. This can include but is not limited to reduction, broadcast, gather, among other things. The processor 140 can also manage synchronization between tasks within the node 105A and coordinate with other nodes, such as nodes 105B and 105C to ensure collective operations proceed in the correct sequence.

The memory 150 can serve as storage space for data that the processor 140 may use during computation. In the node 105A or other nodes of a collective algorithm, the memory 150 can store information regarding the collective algorithm 160. Such information includes the hierarchical level of the node with respect to the packets that it receives and delivers, using the hierarchical level determinant 180 (e.g., a software application).

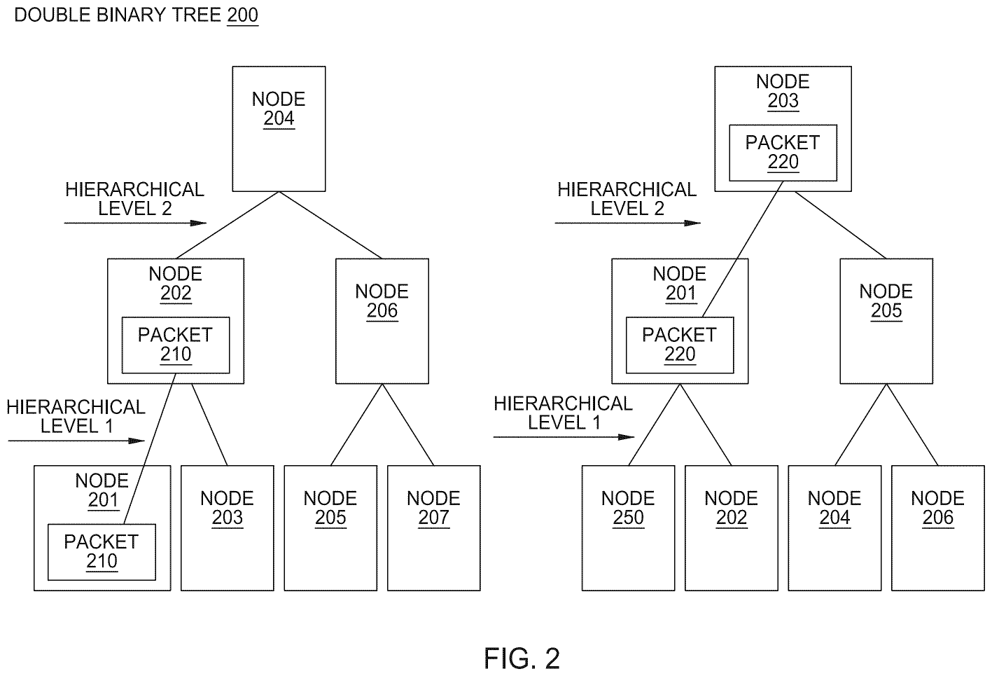

FIG. 2 illustrates packets distributed in a collective algorithm between different nodes of different hierarchical levels in the double binary tree algorithm 200. FIG. 2 illustrates a non-limiting example of prioritizing earlier hierarchical level packets.

A double binary tree collective algorithm is designed to allow data communication in parallel computing with a hierarchical structure. It can be useful for collective operations such as broadcast, reduction, allreduce, among others. A double binary tree collective algorithm organizes nodes into an overlapping binary tree structure, similar to what is shown. The multiple levels, such as the depicted hierarchical level 1, and hierarchical level 2, facilitate data transfer.

The hierarchical structure of a double binary tree collective algorithm can reduce communication overhead by performing computation and data aggregation at lower hierarchical levels. As part of hierarchical level one, the node 201 sends a packet 210 to node 202. As part of hierarchical level two, Node 201 also sends a packet 220 to node 203. That is, FIG. 2 illustrates a situation where a node (e.g., Node 201) has packets ready to send as part of two different hierarchical levels at the same time.

Delivering the packet 210 is associated with a hierarchical level one, and delivering the packet 220 is associated with the hierarchical level two. Both packets are to be delivered from the node 201. If the node 201 prioritizes delivering the packet 220 over the packet 210, the data pendency for hierarchical level two on hierarchical level two is unresolved, ultimately delaying the algorithm. A higher hierarchical level, such as hierarchical level two, has more data dependencies than a respectively lower hierarchical level, such as hierarchical level one. For example, the packet 220 being received by node 203 is of hierarchical level two. The node 203 receiving the packet 220 depends on the node 201 delivering the packet 220, which depends on the nodes 250 and 202 delivering to node 201, and the node 205 which depends on receiving packets from the node 204 and the node 206. The node 202 receiving the packet 210 from the node 201 is of hierarchical level one. The delivery of packets associated with higher hierarchical levels can execute in a timely manner if the delivery of packets to lower hierarchical levels, which they depend on, have been executed. Providing more bandwidth to deliver packets to nodes of lower hierarchical levels helps ensure that once the higher hierarchical levels of the algorithm are reached, they can execute with a lower likelihood of unresolved data dependencies, as their data dependencies on the completion of lower hierarchical level packet deliveries is more likely to be satisfied. If more bandwidth is provided to deliver the packet 220 from the node 201 rather than to deliver the packet 210 from the node 201, the execution of node 202 may be delayed, and in turn delaying the execution of the algorithm.

As the packets 210 and 220 are sent from node 201 in parallel, the NIC 120 associated with the node 201 may provide more bandwidth for delivering the packet 210 of hierarchical level one than to the packet 220 of hierarchical level two. It may be that more bandwidth in general is allocated to delivering packets of lower hierarchical levels, or that more bandwidth is provided to delivering packets of lower hierarchical levels when it is established that the packets of lower hierarchical levels would otherwise be delivered after packets of higher hierarchical levels without the extra bandwidth. Normally, the packets for lower level will be sent before packets for higher levels are ready to be sent. But if there is congestion associated with a path associated with the lower hierarchical level, the situation shown in FIG. 2 may occur, where packets for multiple hierarchical levels are ready to be sent in parallel. In this case, the NIC 120 can automatically assign different bandwidths for delivering the packets using the bandwidth allocator 130. In another embodiment, the NIC 120 may assign different bandwidths after detecting congestion in a lower hierarchical level.

This helps to ensure that node 201 finishes its hierarchical level one packet 210 delivery before its hierarchical level two packet 220 delivery.

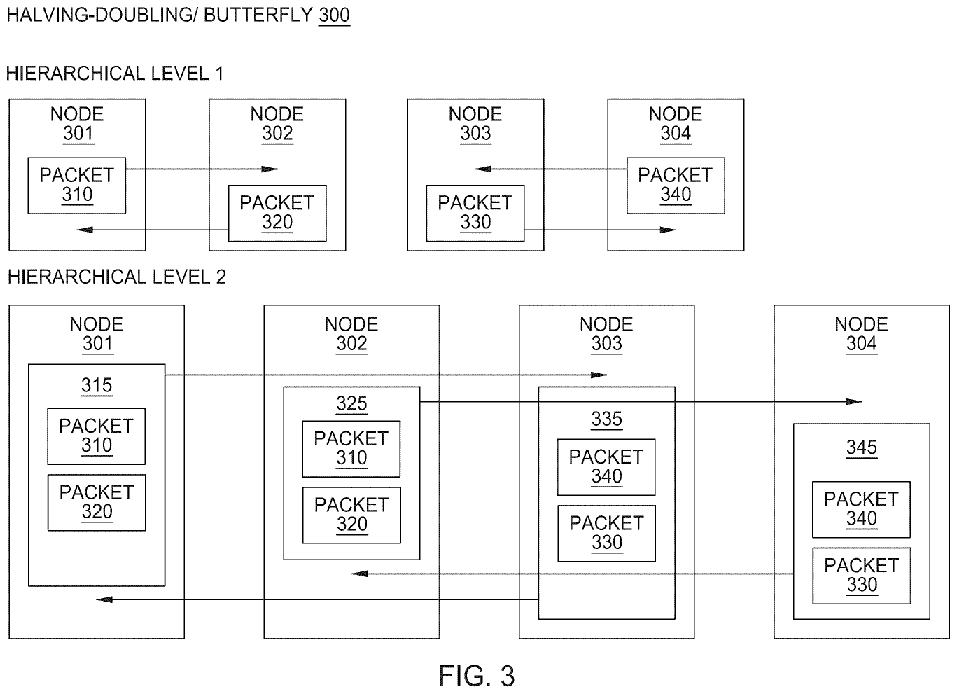

FIG. 3 illustrates packets distributed in a collective algorithm between different nodes of different hierarchical levels in the halving-doubling, or butterfly algorithm 300. A butterfly algorithm can be used in parallel computing to perform the collective operations of broadcast, reduction, and allreduce, among others. In a butterfly algorithm, at each successive hierarchical stage, the exchanged message size is halved and the distance between the nodes exchanging messages is doubled. While the size of the messages are progressively reduced, the distance between the nodes involved in the communication is simultaneously increased. For example, initially, at the first hierarchical stage, the nodes can exchange large masses with immediate neighboring nodes. As the algorithm advances to the next level, the message size can be halved, and a node can exchange data with another node that is twice the distance away compared to the previous stage. This process can continue through successive hierarchical levels, with each level halving the message size and doubling the exchange distance. At the final level, the smallest messages are exchanged over the longest distances.

As depicted, the node 303 sends the packet 330 at the first hierarchical level, and the node 304 waits to receive that packet 330 before moving to the second hierarchical level. At the second hierarchical level, the node 303 sends the packet 335, comprising information from packets 340 and 330, to node 301. The NIC 120 associated with the node 303 may ensure that node's 303 packet 330 is delivered to node 304 in hierarchical level one, allowing the node 304 to move to hierarchical level two, before the NIC 120 associated with node 303 enables the packet 335 of node 303 to send to node 301 at the hierarchical level two. The NIC 120 can help ensure this by providing more bandwidth to deliver the packet 330 to the node 304. It may be that more bandwidth in general is allocated to delivering packets of lower hierarchical levels, or that more bandwidth is provided to delivering packets of lower hierarchical levels when it is established that the packets of lower hierarchical levels would be delivered after packets of higher hierarchical levels without the extra bandwidth. This increases the likelihood that node 303 finishes its hierarchical level one packet 330 delivery first, so that the node 304 does not have to wait on node 303 sending its packet 335 delivery associated with hierarchical level two before the node's 304 deliveries can proceed.

When two packets from the same node, have different hierarchical level associations, the NIC 120 associated with the node increases the likelihood that the packet associated with the lower hierarchical level is delivered before the packet associated with the higher hierarchical level.

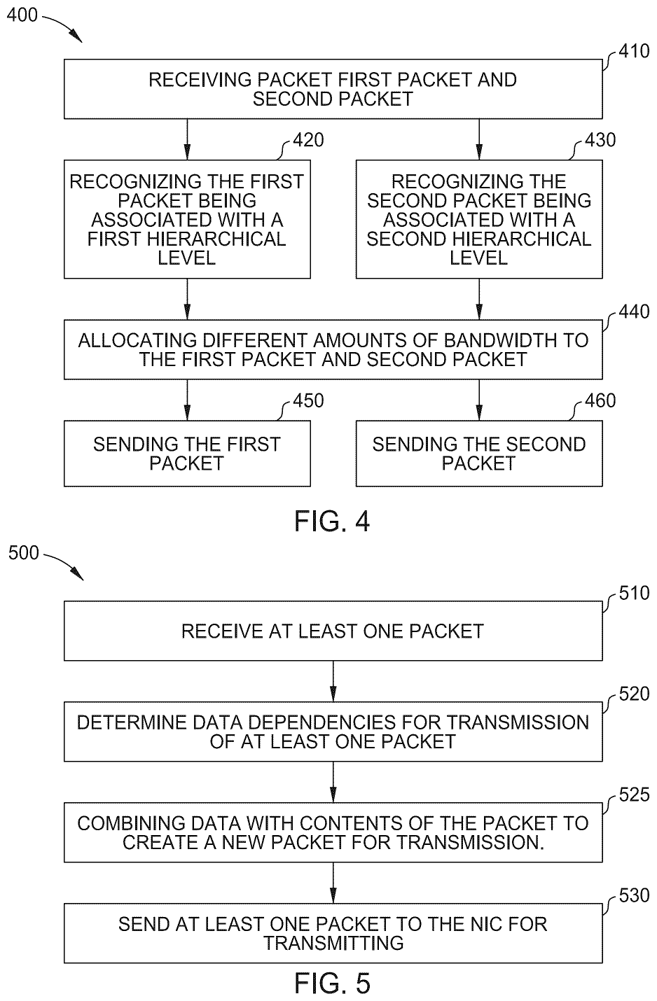

FIG. 4 illustrates a flow diagram that shows the NIC 120 assessing and sending packets of a collective algorithm in parallel.

At block 410, the NIC 120 receives a first packet and a second packet from the node 105A of a collective algorithm. When the NIC 120 receives the packets for transmission, the processor 140 may have organized the data into a format suitable for network communication. This can include placing the data into an area of the node's 105A memory 150 that the NIC 120 has access to. The NIC 120 can read the data of the packet and determine and check for addressing information, errors, etc.

When the NIC 120 receives packets, such as packets 110A and 110B, which can be sent in parallel, it can use packet headers to determine the appropriate destinations. Packet headers can include details such as source and destination addresses (such as Ethernet or IP addresses for internet based communications), to direct the packet to its indented recipient node. Headers can also contain information that dictates the way packets should be handled and routed.

When the NIC 120 receives multiple packets, it can use parallel parsing capabilities to handle them. It can use hardware-based parsing to quickly extract header information from the packets. This allow multiple packets to be examined and processed concurrently.

In the current embodiment, part of the extracted header information can include the hierarchical level associated with each packet, from the hierarchical level determinant 180. It can also be that nodes are programmed to know which packets to expect and which hierarchical level they belong to without packet headers, as the whole machine is executing a single parallel program. It can also be that even if packet headers are used, the nodes are programmed to insert those headers. For example, a packet may contain fields that are recognized by the NIC as indicators of the hierarchical level, or priority, of the packet.

At blocks 420 and 430, the NIC 120 recognizes the hierarchical levels associated with the first packet and the second packet. When the NIC 120 receives packets from the node (or host), it can use information provided to determine the hierarchical level associated with the packets. This can come from a more explicit labeling from the hierarchical level determinant 180 of the node 105A, or it can be more implicit. Implicit information regarding the hierarchical level associated with the packet can be from interpreting hierarchical levels from encoded address information, among other things. Once the hierarchical level associated with the packets for delivery have been recognized, the NIC determines an appropriate amount of bandwidth to provide the packets that are to be sent in parallel.

At block 440, the NIC allocates different amounts of bandwidth to the first packet and the second packet for transmission. The amount of bandwidth provided depends on the level of hierarchy associated with each packet. In some embodiments, because the first packet is associated with a lower level of hierarchy, it is provided more bandwidth than the second packet which is associated with a higher level of hierarchy. The NIC 120 allocates an appropriate amount of bandwidth to each packet that to prioritize the delivery of the packet corresponding to a respectively lower hierarchical level over the packet corresponding to a respectively higher hierarchical level.

At blocks 450 and 460, the NIC 120 sends the first packet and the second packet in parallel. The NIC 120 may include multiple transmit queues, allowing this parallel transmission to occur. The transmit queues may organize the packets based on criteria discussed above, including hierarchical level association. The packets sent in parallel may be sent at different speeds, as different amounts of bandwidth may be provided to each packet being transmitted.

FIG. 5 illustrates a flow diagram 500 depicting the node's interaction with the NIC 120.

At block 510, the node 105A receives at least one packet. When the node 105A receives a packet, it may be from a different node in the collective algorithm.

At block 520, the node 105A determines data dependencies the packet may have. The data dependencies of the packet can be determined through the analysis of its contents and the context provided by the network 115 protocols and communication patterns. When the node 105A receives a packet, the node 105A may inspect the headers embedded within the packet. This can include but is not limited to metadata such as source addresses, destination addresses, etc. This information can provide insight on the packet's relationship to the other packets exchanged between nodes, shedding light on the level of hierarchy it belongs to, and the number of data dependencies it may have.

Non limiting examples of the node determining different data dependencies includes but is not limited to, analyzing sequence numbers that can indicate the order the packets should be processed, analyzing destination addresses that indicate how deep into the algorithm the packet should be sent, or analyzing timestamps or synchronization markers that may indicate temporal dependencies between packets, etc.

At block 525, the node 105A uses the data from the packet to generate a new or updated packet suitable for transmission. When the node 105A receives a packet, the packet may undergo processing. This processing can include but is not limited to, removing the headers of the packet, extracting data that may be used to transmit the packet, and combining new data with the existing data of the packet. The new data, which may be based on the processing outcome of the packet, can generate a new or updated packet suitable for transmission. This can include new transport headers, among other things. The new or updated packet, derived from the received packet, can then be transmitted to the NIC 120 for transmission.

At block 530, the node 105A sends the packet to its NIC for transmitting. When the node is able to associate the packet to where it belongs in the collective algorithm, including determining its data dependencies and its associated hierarchical level, it may sent it to the NIC for transmission. The operating system of the node interacts with the NIC 120 via system calls device specific interfaces, etc. after it has been adequately prepared and is deemed ready for transmission.

In one embodiment, the DPU 600 is a programmable processor designed to efficiently handle data-centric workloads such as data transfer, reduction, security, compression, analytics, and encryption, at scale in data centers. The DPU 600 can be one implantation of the NIC 120 discussed above. The DPU 600 can improve the efficiency and performance of data centers by offloading workloads from a host central processing unit (CPU) or graphic processing units (GPUs). While CPUs and GPUs can specialize on compute, the DPU may specialize in data movement. The DPU 600 can communicate with host CPUs and GPUs to enhance computing power and the handling of complex data workloads.

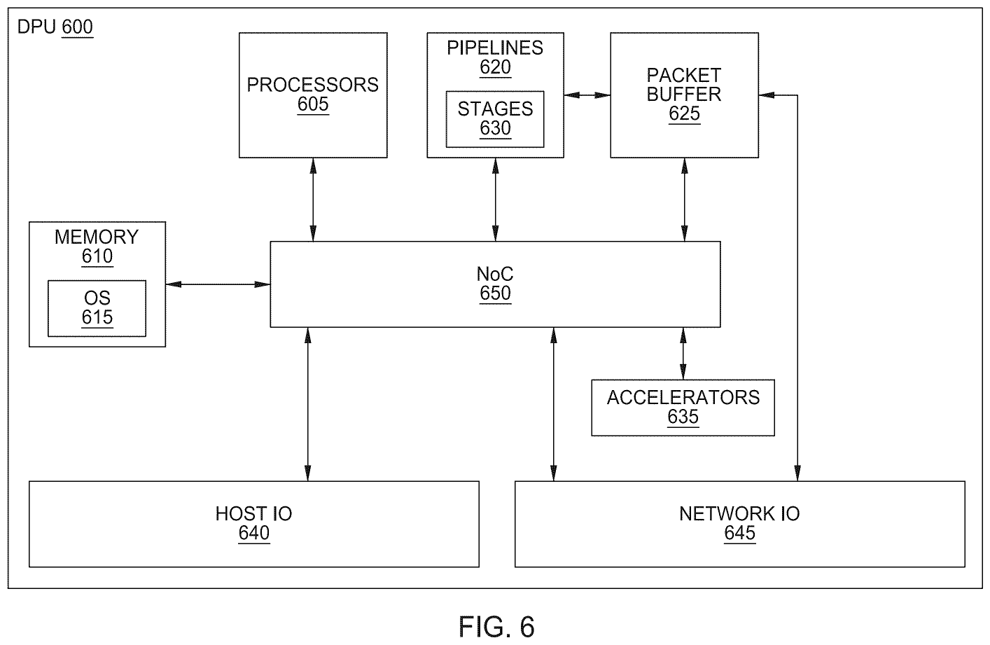

FIG. 6 illustrates an example data processing unit, according to one embodiment herein. The DPU 600 includes a plurality of processors 605. In one embodiment, the processors 605 include any number of processing cores. In one embodiment, the processors 605 may be CPUs. The processors 605 can form one or more CPU core complexes. The processors 605 can be any hardware circuitry that uses an instruction set architecture (ISA) to process data, such as a complex instruction set computer (CISC) or reduced instruction set computer (RISC).

The memory 610 can include volatile or non-volatile memory such as random access memory (RAM), high bandwidth memory (HBM), and the like. The memory 610 can include an operating system (OS) 615 that is separate from the host OS.

In one embodiment, the DPU may be in (or be used to implement) a network interface controller/card (NIC) such as a SmartNIC that processes packets before they are forwarded to a host (e.g., a host CPU or GPU). In one embodiment, the DPUs 600 are fully programmable P4 DPUs. The DPU 600 includes multiple pipelines 620 (which can be the same type or different types) for processing received network packets stored in a packet buffer 625. In this example, the pipelines 620 has direct connections to the packet buffer 625.

The pipelines 620 can operate in parallel. Further, the pipelines 620 can be the same type of pipeline (e.g., perform the same tasks). In other embodiments, the DPU 600 may have different types of pipelines 620. For example, the DPU 600 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 620 include multiple stages 630 where received packet data is processed at each stage 630 before being passed to the next stage. This packet data could be the entire packet or just a portion of the packet. For example, a parser in the DPU 600, which is upstream from the pipelines 620, may parse out a particular portion of a received packet (e.g., a packet header vector (PHV)) which is then sent to the one of the pipelines 620.

The stages 630 can include circuitry or hardware. In one embodiment, the stages 630 can be programmed using a pipeline programming language, such as P4. In one example, the stages 630 in one pipeline 620 perform the same functions of the stages 630 in another pipeline 620. However, in other embodiments, the stages may perform different functions.

In addition to the stages, the pipelines 620 may each include memory, which can be referred to as local memory. This memory can store local tables that indicate how, or if, a particular packet should be processed at the stages 630. For example, one of the stages in the pipelines 620 can perform a lookup to read a policing entry in a table to determine whether an entity associated with the packet has exceeded a rate limit (e.g., a packet rate limit, a data rate limit, or both).

The DPU 600 can include accelerators 635 to perform specialized tasks associated with data movement. The accelerators 635 can include a cryptography accelerator, a data compression accelerator, as well as accelerators for performing regex or dedupe.

To communicate with the host and a network, the DPU 600 includes host input/output (IO) 640 and network IO 645. The host IO 640 can include a PCIe interface, or any suitable protocol for communicating with a CPU or GPU in the host. The network IO 645 can include Ethernet interfaces, and the like for communicating with a network.

The DPU 600 includes a network on chip (NoC) 650 for interconnecting the various components discussed above. While a NoC is disclosed, the DPU 600 can include any suitable on-chip network. While some components in the DPU 600 may rely on the NoC 650 to communicate with other components, the DPU 600 can also include connections between components that bypass the NoC 650. For example, the packet buffer 625 can have a connection to the network IO 645 that bypasses the NoC 650. Similarly, the pipelines 620 can exchange packet data with the packet buffer 625 without having to rely on the NoC 650. However, to transfer data to the processors 605, the pipelines 620 may use the NoC 650.

In one embodiment, the DPU 600 includes security and management features such as offering a hardware root of trust, secure boot, and the like.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A method, comprising:
receiving a first packet and a second packet from a node of a collective algorithm, wherein the first packet corresponds to a first hierarchical level of the collective algorithm, and the second packet corresponds to a second hierarchical level of the collective algorithm;
allocating a first amount of bandwidth to the first packet and a second, different amount of bandwidth to the second packet; and
transmitting, in parallel, the first packet to a first destination node using the first amount of bandwidth, and the second packet to a second destination node using the second, different amount of bandwidth.

2. The method of claim 1, wherein a higher hierarchical level of the collective algorithm has data dependencies on one or more lower hierarchical levels of the collective algorithm.

3. The method of claim 2, wherein the higher hierarchical level can be completed only after the data dependencies with the one or more lower hierarchical level have been satisfied.

4. The method of claim 1, wherein the first packet is sent to the first destination node of the first hierarchical level and the second packet is sent to the second destination node of the second hierarchical level, wherein the node has received at least two other packets from two other nodes in the collective algorithm as part of the first hierarchical level before transmitting the second packet to the second destination node.

5. The method of claim 1, wherein respectively more bandwidth is provided to transmit the first packet to the first destination node than to transmit the second packet to the second destination node.

6. The method of claim 4, wherein the first destination node receives the first packet before the second destination node receives the second packet.

7. The method of claim 1, wherein the collective algorithm performs an allreduce operation.

8. The method of claim 1, wherein the collective algorithm performs an alltoall operation.

9. A network device comprising:
a circuitry configured to:
receive a first packet and a second packet from a node of a collective algorithm, wherein the first packet corresponds to a first hierarchical level of the collective algorithm, and the second packet corresponds to a second hierarchical level of the collective algorithm;
allocate a first amount of bandwidth to the first packet and a second, different amount of bandwidth to the second packet; and
transmit, in parallel, the first packet to a first destination node using the first amount of bandwidth, and the second packet to a second destination node using the second, different amount of bandwidth.

10. The network device of claim 9, wherein a higher hierarchical level of the collective algorithm has data dependencies on one or more lower hierarchical levels of the collective algorithm.

11. The network device of claim 10, wherein the higher hierarchical level can be completed only after the data dependencies with the one or more lower hierarchical level have been satisfied.

12. The network device of claim 9, wherein the first packet is sent to the first destination node of the first hierarchical level and the second packet is sent to the second destination node of the second hierarchical level, wherein the node has received at least two other packets from two other nodes in the collective algorithm as part of the first hierarchical level before transmitting the second packet to the second destination node.

13. The network device of claim 9, wherein respectively more bandwidth is provided to transmit the first packet to the first destination node than to transmit the second packet to the second destination node.

14. The network device of claim 12, wherein the first destination node receives the first packet before the second destination node receives the second packet.

15. A system comprising:
a node, wherein the node is configured to:
generate a first packet, and a second packet, wherein the first packet comprises an indication of an association with a first hierarchical level of a collective algorithm, and the second packet comprises an indication of an association with a second hierarchical level of the collective algorithm; and
a network device, wherein the network device is configured to:
receive, from the node, the first packet and the second packet;
allocate a first amount of bandwidth to the first packet and a second, different amount of bandwidth to the second packet; and
transmit, in parallel, the first packet to a first destination node using the first amount of bandwidth, and the second packet to a second destination node using the second, different amount of bandwidth.

16. The system of claim 15, wherein a higher hierarchical level of the collective algorithm has data dependencies on one or more lower hierarchical levels of the collective algorithm.

17. The system of claim 16, wherein the higher hierarchical level can be completed only after the data dependencies with the one or more lower hierarchical level have been satisfied.

18. The system of claim 15, wherein the first packet is sent to the first destination node of the first hierarchical level and the second packet is sent to the second destination node of the second hierarchical level, wherein the node has received at least two other packets from two other nodes in the collective algorithm as part of the first hierarchical level before transmitting the second packet to the second destination node.

19. The system of claim 15, wherein respectively more bandwidth is provided to transmit the first packet to the first destination node than to transmit the second packet to the second destination node.

20. The system of claim 18, wherein the first destination node receives the first packet before the second destination node receives the second packet.
